(19) United States
(12) Patent Application Publication
(10) Pub. No.: US 2015/0231534 A1
(43) Pub. Date: Aug. 20, 2015

(54) In-situ Flush Apparatus for Water or Waste Water Filters

(71) Applicant: Xylem Water Solutions Zelienople LLC, Zelienople, PA (US)

(72) Inventors: Dean T. Berkebile, Cranberry Township, PA (US); John L. Geibel, JR., Butler, PA (US); Robert Lee Wiley, JR., Ellwood City, PA (US)

(21) Appl. No.: 14/588,706

(22) Filed: Jan. 2, 2015

Related U.S. Application Data
(60) Provisional application No. 61/923,424, filed on Jan. 3, 2014.

(51) Int. Cl. B01D 29/66

(52) U.S. Cl. CPC B01D 29/66

(57) ABSTRACT

A flush apparatus for a filter underdrain system can include a fluid connection member having a body with a first end and a second end, the first end adapted to connect to a fluid source; a top plate connected to the second end of the fluid connection member; and a bottom plate opposing the top plate and adapted to engage a top portion of an underdrain system, the bottom plate having orifices that distribute fluid to the underdrain system to transport materials through the underdrain system. A system for cleaning unwanted materials from a water or waste water treatment filter and a method of transporting unwanted materials through an underdrain system are also disclosed.

### CROSS REFERENCE TO RELATED APPLICATIONS

This application claims the benefit of U.S. Provisional Application No. 61/923,424, filed Jan. 3, 2014, the entire contents of which is hereby incorporated by reference.

### BACKGROUND OF THE INVENTION

1. Field of the Invention

The present invention relates to water or waste water filters and, in particular, to a flush apparatus for water or waste water filters.

2. Description of Related Art

Gravity filters are used to separate suspended solids from water. The main components of gravity filters are filtering media and underdrain blocks. Underdrain blocks are generally square, rectangular, or triangular in cross section and have a long longitudinal axis as compared to their cross section. They are attached end-to-end to form long sections called laterals, or are extruded to length, or are fabricated to length. Filter underdrain laterals are laid on the floor of the filter tank one next to the other in parallel rows to define gas and liquid flow conduits below a bed of filtering media. The filtering media is used to capture dirt and other unwanted materials from a liquid being filtered as the liquid passes through the media. The filter media can be supported by a media barrier such as a media retainer so that media will not pass into the underdrain block.

The gas and liquid flow conduits make possible the collection of filtered liquid during filtration and the distribution of gas and liquid for backwash. Typically, a common main conduit (known as a “flume”) is located immediately next to or under the filter tank to collect the effluent filtered liquid from the underdrain laterals during filtration.

Within the different chambers of the underdrain, debris can accumulate, normally as a result of some type of structural or operational failure. This debris can come from a number of sources. For instance, inadvertent construction debris can be introduced through the effluent piping network connected to the flume. In addition, a filter underdrain system can have a structural failure that permits granular filter media to bypass the media barrier component, allowing media to accumulate within the filter underdrain system.

The removal of debris and media from the underdrain is desirable, as the debris and media can have an adverse effect on the operation of the underdrain, and as a result, adversely affect the performance of the filter. For example, debris accumulation can cause ineffective cleaning, or backwashing, of the media. Debris accumulation can also cause areas of unequal filtering rates across the length and width of the filter due to excessive pressure drop in affected areas. Further, debris can be a source for the growth of harmful bacteria.

While nearly all filter underdrain systems can be physically cut open to employ flushing techniques for debris removal, it is advantageous to clean the media from the underdrain systems without altering the physical characteristics of the underdrain system. By physically cutting a hole or opening into the underdrain system, the structural strength of the underdrain system can be compromised upon repair.

One option for removing debris without cutting holes or openings is to discharge filtered water into one of a number of types of effluent collection configurations, such as a flume mentioned above. If debris from within a filter underdrain system can be forced in-situ to the effluent collection area, the debris can be collected and removed from the filter underdrain system without physically altering the underdrain.

Thus, it would be desirable to provide an apparatus that utilizes pressurized fluid (water and/or air) to move debris from the various chambers of the underdrain system, and to transport the debris into the filter effluent chamber for collection and removal.

### SUMMARY OF THE INVENTION

In accordance with one embodiment of the present invention, an in-situ flush apparatus for a filter underdrain system can include: a fluid connection member having a body with a first end and a second end, the first end adapted to connect to a fluid source; a top plate connected to the second end of the fluid connection member; and a bottom plate opposing the top plate and adapted to engage a top portion of an underdrain system, the bottom plate comprising orifices that distribute fluid to the underdrain system to transport materials through the underdrain system. The apparatus can also include a middle plate positioned between the top plate and the bottom plate, the middle plate includes a plurality of channels. The plurality of channels direct fluid to the orifices of the bottom plate. A seal, such as a gasket, can also be attached to a portion of the bottom plate.

In certain embodiments, the fluid connection member contains valves to control the flow of water from the fluid source to each channel. The fluid connection member can also include a flowmeter to control the pressure of fluid and a pressure gauge adapted to measure the pressure of fluid.

The present invention is also directed to a system for cleaning unwanted materials from a water or waste water treatment filter that includes: an underdrain system that includes an underdrain bock; a fluid source; and the in-situ flush apparatuses described above. The system can further include an effluent collection device that receives the materials transported through the underdrain block. The effluent collection device can be a flume.

The system can also include a hose extending from the effluent collection device to the underdrain block. In some embodiments, the system includes a downcomer stem positioned in a top wall of the underdrain block. A hose can be used to provide additional fluid to the underdrain block through the downcomer stem.

The present invention also includes a method of transporting unwanted materials through a filter underdrain system, the method includes: positioning the in-situ flush apparatuses described above onto a top portion of an underdrain system; attaching the first end of the fluid connection member to the fluid source; and distributing fluid from the fluid source out of the flush apparatus through orifices positioned in the bottom plate of the flush apparatus and into the underdrain system. The unwanted materials can be transported from the underdrain system to an effluent collection device.

### BRIEF DESCRIPTION OF THE DRAWINGS

FIG. 1 is a perspective view of a media retainer and an underdrain of a filter underdrain system according to an embodiment of the present invention;

FIG. 2 is a front cross-sectional view of a filter underdrain system according to an embodiment of the present invention;

FIG. 3 is a front view of a filter with a collection flume and underdrain blocks in accordance with an embodiment of the present invention;

FIG. 4 is a front cross-sectional view of a flush apparatus according to one embodiment of the of the present invention;

FIG. 5 is a perspective view of a flush apparatus positioned on top of an underdrain block in accordance with one embodiment of the present invention;

FIG. 6 is a bottom view of the bottom plate of a flush apparatus in accordance with one embodiment of the present invention;

FIG. 7 is a bottom view of the bottom plate of a flush apparatus partially removed from an underdrain block in accordance with one embodiment of the present invention;

FIG. 8 is a perspective view of a flush apparatus positioned on top of an underdrain system in accordance with another embodiment of the present invention;

FIG. 9 is a front cross-sectional view of a flush apparatus illustrating the flow of fluid during flushing in accordance with one embodiment of the present invention;

FIG. 10 is a perspective view of a hose and nozzle that can provide additional motive force during flushing of debris in accordance with one embodiment of the present invention;

FIG. 11 is a perspective view of a downcomer stem that can be used to distribute fluid for additional motive force during flushing of debris in accordance with another embodiment of the present invention; and

FIG. 12 is a perspective view of a flowmeter in accordance with one embodiment of the present invention.

### DESCRIPTION OF THE INVENTION

For purposes of the description hereinafter, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

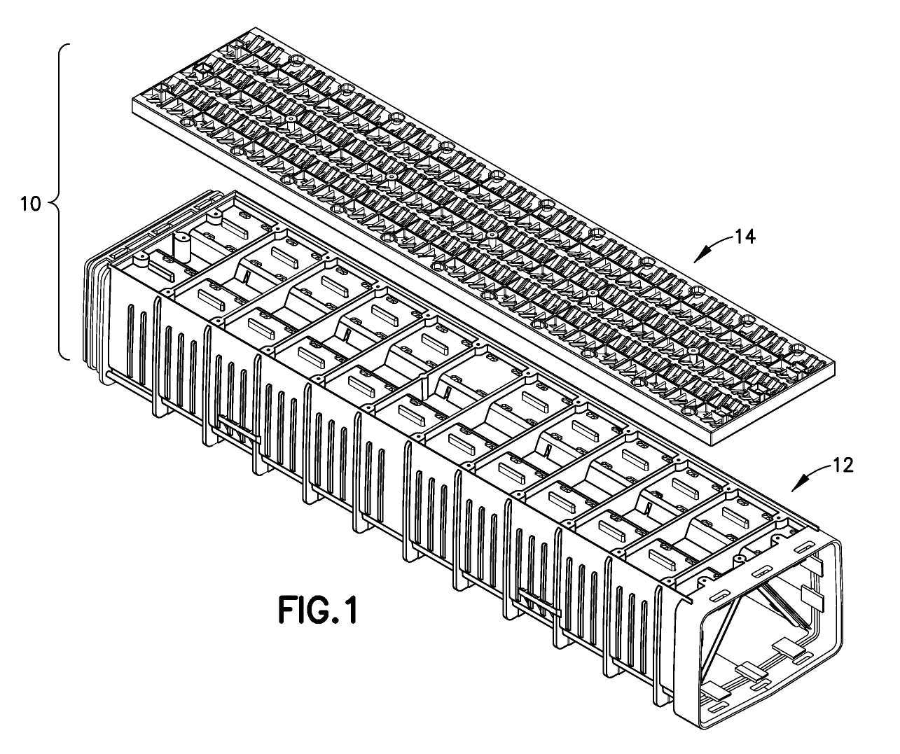

Referring to FIG. 1, a filter underdrain system 10 in accordance with one embodiment of the present invention can include at least one underdrain block 12. In certain embodiments, the underdrain system 10 also includes a filter media retainer 14 that can be mounted on top of the underdrain block 12. A layer or multiple layers of filter media (not shown) is poured on top of the filter media retainer 14. As described above, the filter media acts to remove undesirable particles from a liquid that is being filtered through the filter underdrain system 10.

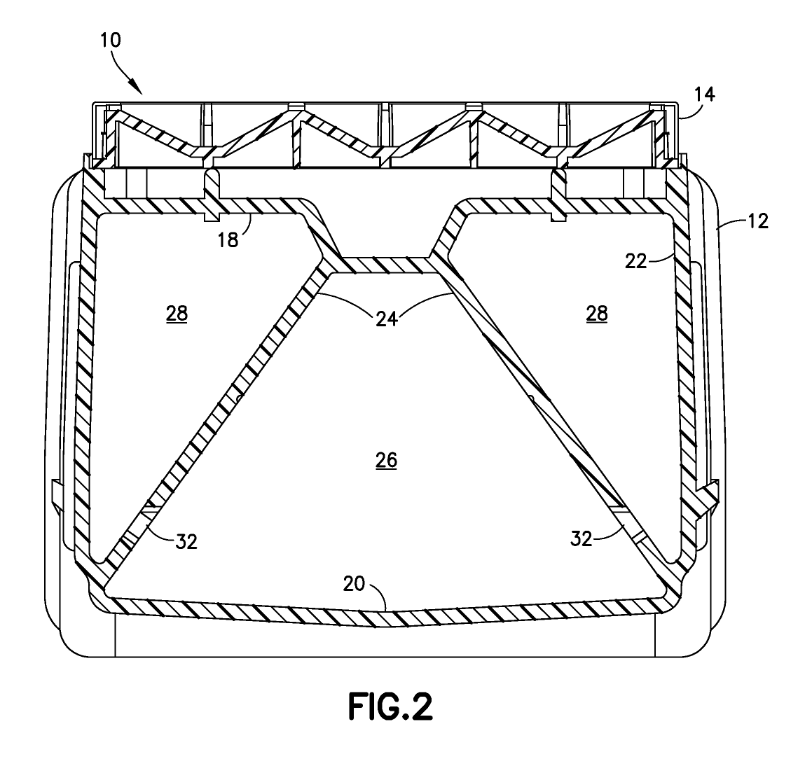

In certain embodiments, as shown in FIG. 2, the underdrain block 12 can have a plurality of exterior walls including a top wall 18, a bottom wall 20, and a pair of side walls 22 extending between the top wall 18 and the bottom wall 20. A plurality of internal walls 24 divide the hollow interior of the underdrain block 12 into a primary horizontal chamber 26 and two secondary horizontal chambers 28 positioned on opposite sides of primary horizontal chamber 26. Additionally, a plurality of channels 32 are provided on internal walls 24 to provide fluid communication between primary horizontal chamber 26 and secondary horizontal chambers 28. Non-limiting examples of suitable underdrains are also described in United States Publication No. 2014/0166567 and U.S. Pat. No. 5,489,388, both of which are incorporated by reference herein in their entirety.

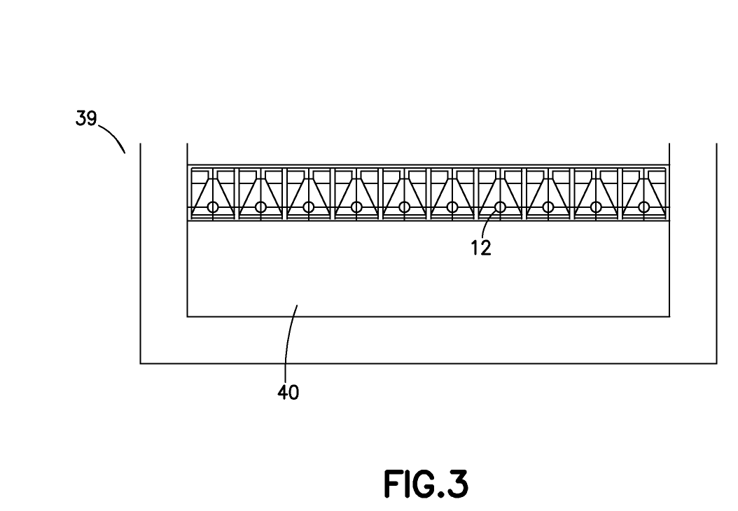

In certain embodiments, the primary chamber 26 can be connected to an effluent collection chamber 40, such as a flume, which, in turn, conveys the filtered liquid to a clearwell (not shown) for distribution to the consumer. FIG. 3 illustrates a series of underdrain blocks 12 positioned in a filter 39 with an effluent collection chamber 40.

As described above, media and debris can be displaced between the filter media retainer 14 and the top wall 18 of the underdrain block 12. Media and debris can also be displaced into the secondary chambers 28 and the primary chamber 26 of the underdrain block 12. In order to remove the media and debris located in the secondary chambers 28, primary chamber 26, and between the filter media retainer 14 and the top wall 18 of the underdrain block 12, an in-situ flush apparatus 50 can be used. As used herein, “in-situ flush apparatus” refers to an apparatus or device that can flush or displace materials from an underdrain without physically altering the structure of the underdrain block 12.

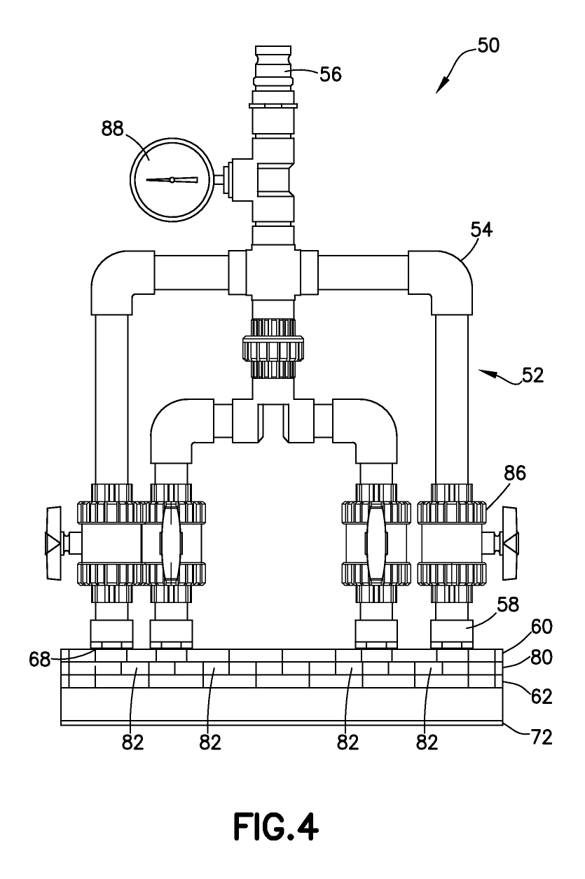

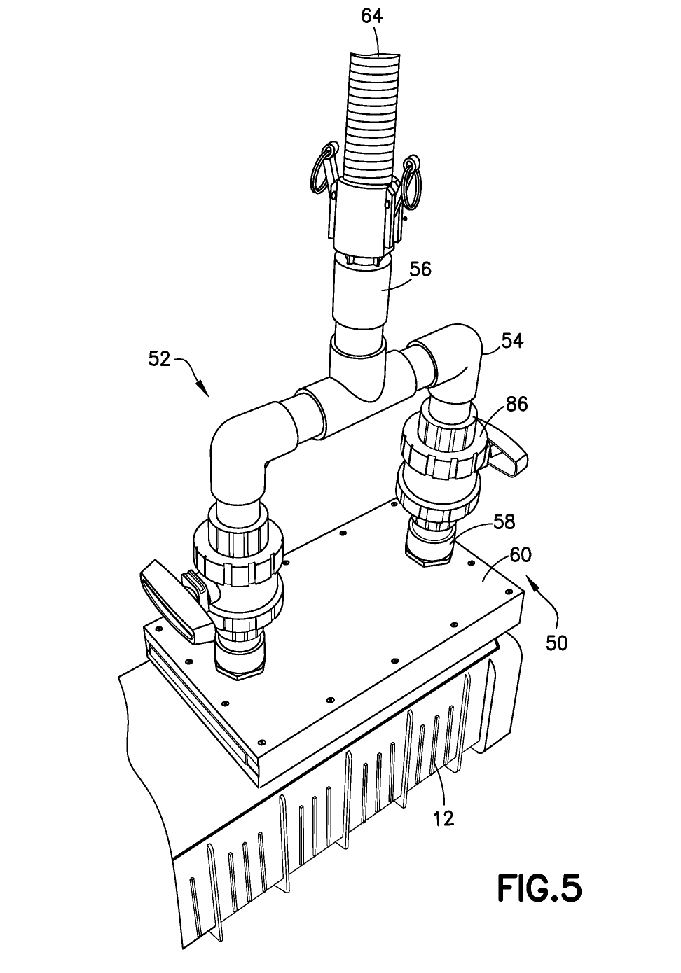

As shown in FIG. 4, the flush apparatus 50 can include a fluid connection member 52 having a body 54 with a first end 56 and a second end 58, a top plate 60, and a bottom plate 62. In certain embodiments, the first end 56 of the fluid connection member 52 can be connected to a fluid source 64, such as a hose, as shown in FIG. 5, and the second end 58 can be connected to the top plate 60. The body 54 of the fluid connection member 52 can be formed from multiple pipes or other connections extending between the top plate 60 and a fluid source 64 and which allows fluid to flow from the fluid source 64 and into the top plate 60. The second end 58 of the fluid connection member 52 can be inserted into the top plate 60 to form at least one connection point 68 between the second end 58 of the fluid connection member 52 and the top plate 60. In certain embodiments, as shown in FIG. 4, the second end 58 of the fluid connection member 52 can be inserted into the top plate 60 to form two or more connection points 68 between the second end 58 of the fluid connection member 52 and the top plate 60. In certain embodiments, the top plate 60 includes holes for receiving the second end 58 of the fluid connection member 52.

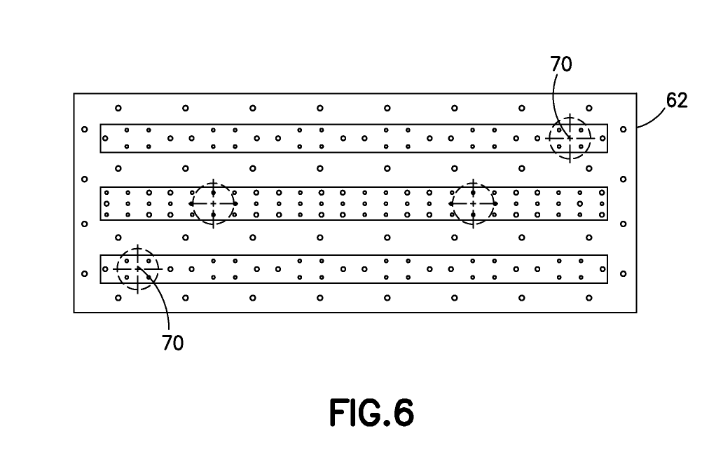

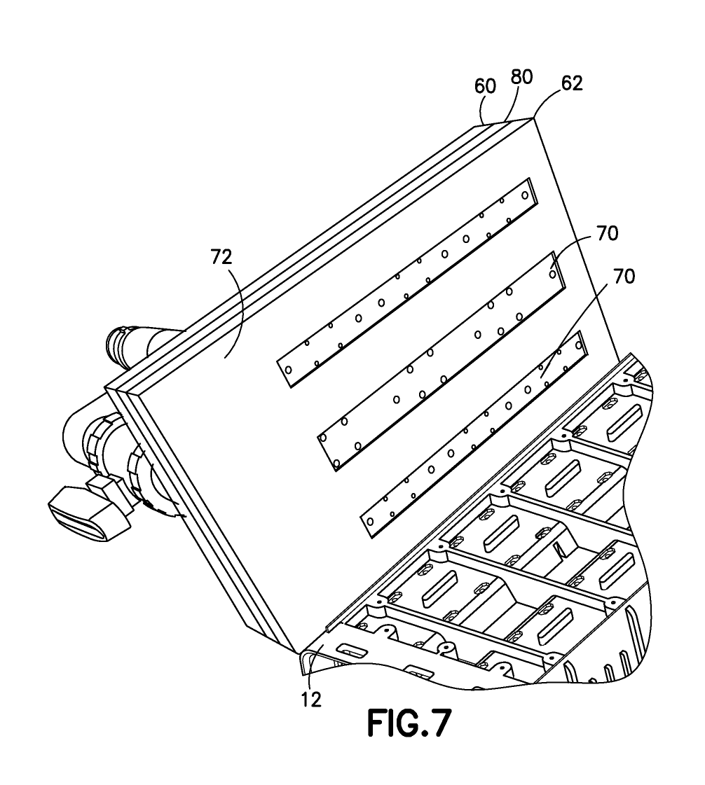

As indicated above, the flush apparatus 50 also includes a bottom plate 62. The bottom plate 62 is positioned opposite the top plate 60 and can include a plurality of orifices 70 as shown in FIGS. 6 and 7. The orifices 70 in the bottom plate 62 allow fluid to exit the flush apparatus 50. As such, fluid from a fluid source 64 can flow through the fluid connection member 52, into the top plate 60, and out through the orifices 70 of the bottom plate 62. Referring to FIG. 6, the orifices 70 can be placed in different areas of the bottom plate 62. Thus, specific orifices 70 will distribute fluid out of specific areas of the bottom plate 62.

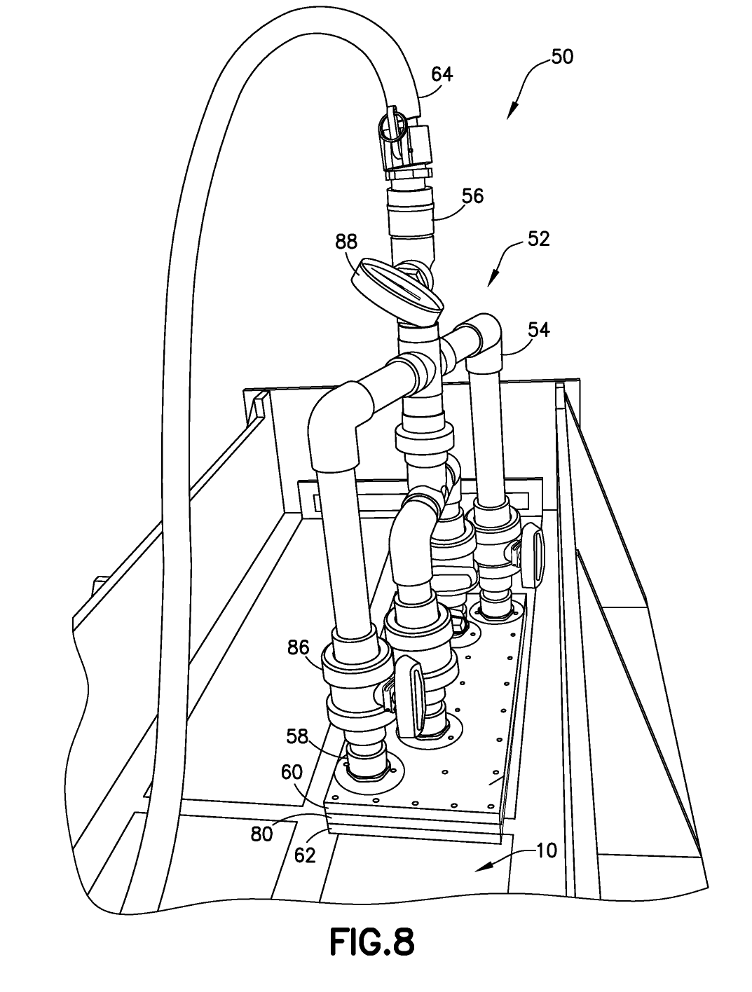

Referring to FIGS. 5 and 8, the bottom plate 62 is further adapted to engage a top portion of an underdrain system 10. In certain embodiments, the bottom plate 62 is adapted to engage the top of a filter media retainer 14. Alternatively, the bottom plate 62 can directly engage the top wall 18 of the underdrain block 12 when a filter media retainer 14 is not used.

In certain embodiments, as shown in FIGS. 4 and 7, a seal 72 can be attached to a portion of the bottom plate 62 without blocking the orifices 70. The seal 72 helps form a tight engagement between the bottom plate 62 and the underdrain system 10. In one embodiment, the seal 72 is a gasket.

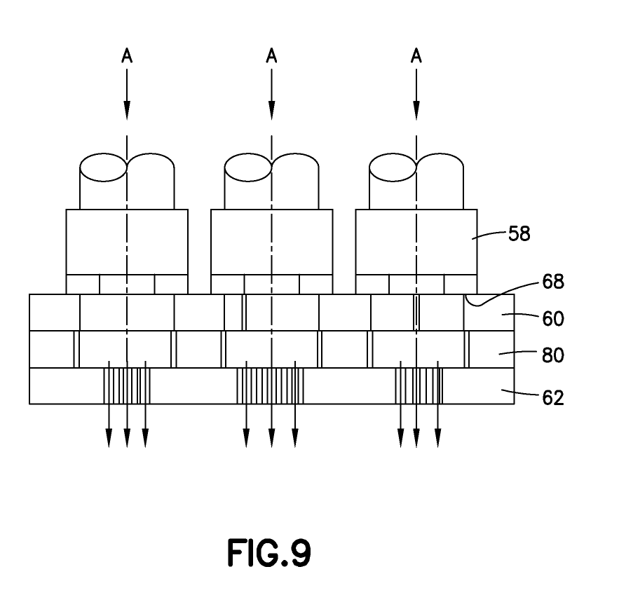

In certain embodiments as shown in FIG. 4, the flush apparatus 50 can also include a middle plate 80 positioned between the top plate 60 and the bottom plate 62. The middle plate 80 can include a plurality of channels 82 that form a labyrinth through which fluid entering the top plate 60 can flow to the orifices 70 of the bottom plate 62. As noted above, the second end 58 of the fluid connection member 52 can be connected to the top plate 60 at one or more connection points 68. Each connection point 68 in the top plate 60 can be associated with a specific channel 82 that leads to designated orifices 70 in the bottom plate 62. Thus, fluid entering a specific connection point 68 will be directed to designated orifices 70 in the bottom plate 62. FIG. 9 is a cross-sectional view of the flow of fluid, represented as reference letter “A”, through the second end 58 of the fluid connection member 52 and the top plate 60, middle plate 82, and bottom plate 62 of the flush apparatus 50.

In addition, the top plate 60, middle plate 80, and bottom plate 62 can be connected together using various methods. For instance, in some embodiments, the top plate 60, middle plate 80, and bottom plate 62 can be connected together with fasteners such as screws. Further, the top plate 60, middle plate 80, and bottom plate 62 can be made of the same material or different materials. In certain embodiments, the top plate 60, middle plate 80, and bottom plate 62 are all made of polyvinylchloride.

Referring to FIG. 4, in certain embodiments, the fluid connection member 52 includes one or more valves 86 to control the flow of fluid entering the top plate 60. Further, different valves 86 can control the flow of fluid through different connection points 68. As a result, fluid can be directed to a single connection point 68 that is associated with a specific channel 82 which in turn leads to designated orifices 70 in the bottom plate 62. This allows control over the location in the bottom plate 62 where fluid will exit and the location in the underdrain system 10 where the fluid will enter. For example, the valves 86 can be controlled so that fluid will only flow through one connection point 68 which is associated with a channel 82 that leads to orifices 70 located in the center region of the bottom plate 62. The valves 86 can then be adjusted so that fluid will only flow through a different connection point 68 which is associated with a channel 82 that leads to orifices 70 located on the outside regions of the bottom plate 62. The ability to control the direction of fluid through the flush apparatus 50 allows specific regions of the underdrain block 12 to be flushed as desired.

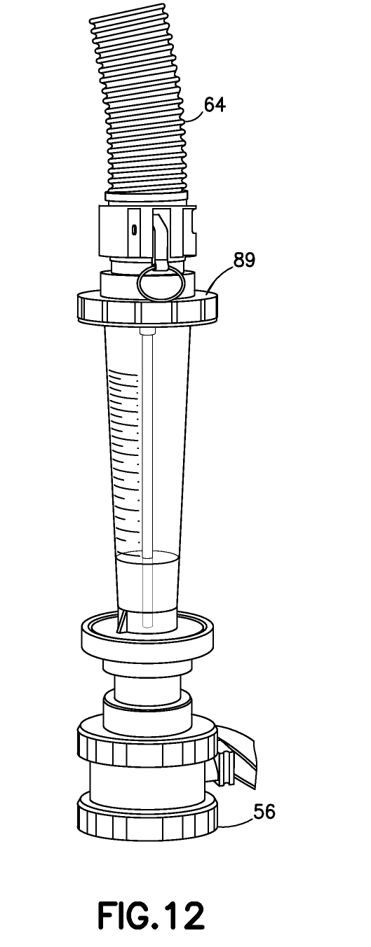

As shown in FIG. 4, the fluid connection member 52 can include a pressure gauge 88 that can measure the pressure of fluid to each channel 82. The fluid connection member 52 can also include a flowmeter 89, such as a rotometer, to control the pressure of fluid to each channel 82. FIG. 12 illustrates a flowmeter 89 that can be used with the present invention. In certain embodiments, the flowmeter 89 can be positioned upstream from the first end 56 of the fluid connection member 52. In such embodiments, as shown in FIG. 12, the flowmeter 89 can be connected between the first end 56 of the fluid connection member 52 and the fluid source 64. The flowmeter 89 can also be positioned between the first end 56 of the fluid connection member 52 and the pressure gauge 88. The pressure gauge 88 and flowmeter 89 help further control the flushing process.

In certain embodiments, when a long underdrain lateral formed from multiple underdrain blocks 12 needs flushed, two or more flush apparatuses 50 can be used to flush media and other unwanted material from the underdrain lateral. For example, two flush apparatuses 50 can be used where one of the flush apparatuses 50 is positioned at an end of the underdrain lateral farthest away from the effluent collection chamber 40. This provides additional motive force in the direction of the effluent collection chamber 40 to ensure the media and unwanted materials are flushed to the effluent collection chamber 40.

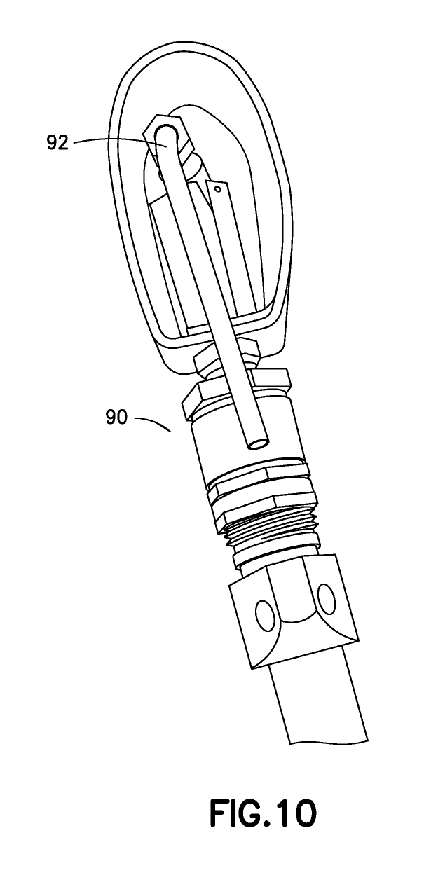

In certain embodiments, there is a direct opening from the effluent collection chamber 40 to the primary chamber 26 of the underdrain block 12. In such circumstances, flexible hoses 90 can be inserted into the primary chamber 26 from the effluent collection chamber 40 with nozzles 92 pointing backward toward the effluent collection chamber 40. The fluid released from the hose 90 can be used to provide additional motive force in the direction of the effluent collection chamber 40. FIG. 10 shows a portion of a hose 90 and nozzle 92 that can be inserted into the primary chamber 26 of the underdrain block 12 to provide additional motive force in the direction of the effluent collection chamber 40.

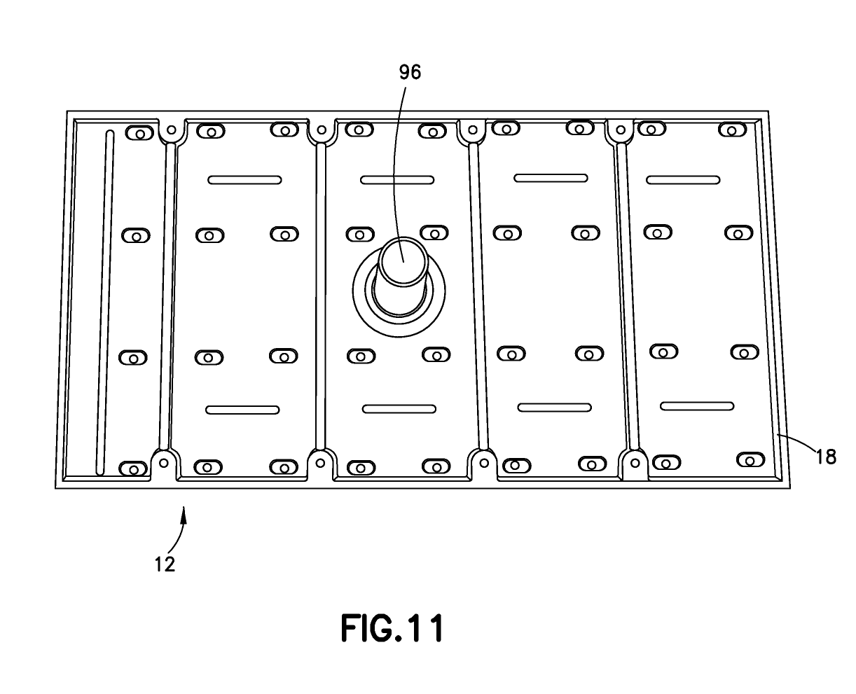

In another embodiment, as shown FIG. 11, a downcomer stem 96 can be positioned through the top of the underdrain system 10. In certain embodiments, as shown in FIG. 12, the downcomer stem 96 is positioned through the top wall 18 of the underdrain block 12. Alternatively, when a filter media retainer 14 is used, the downcomer stem 96 can be positioned through a filter media retainer 14 and the top wall 18 of the underdrain block 12. A hose 90 can then be connected to the downcomer stem 96. Fluid from the hose 90 can assist in forcing media and unwanted material to travel the length of an underdrain lateral.

The present invention is also directed to a method of flushing unwanted materials from an underdrain block 12 using the flush apparatus 50 described above. The method can first include placing a flush apparatus 50 onto a top portion of an underdrain system 10 such that the bottom plate 62 of the flush apparatus 50 engages the top of the underdrain system 10 such as the top wall 18 of the underdrain block 12 or the top of a filter media retainer 14. The flush apparatus 50 can have various sizes and shapes. In one embodiment, the flush apparatus 50 can have the same width of the underdrain block 12. After positioning the flush apparatus 50 onto the underdrain system 10, fluid can be distributed from a fluid source 64 to the fluid connection member 52. Valves 86 positioned on the flush apparatus 50 can be controlled to direct the fluid to a specific connection point 68 formed between the second end 58 of the fluid connection member 52 and the top plate 60. The fluid then flows through the channels 82 to specific orifices 70 located in a designated region of the bottom plate 62. Fluid will flow out of these orifices 70 and into areas of the underdrain block 12 associated with the specific regions of the bottom plate 62 where the fluid will exit. In certain embodiments, the valves 86 can be adjusted so fluid enters a different connection point 68 associated with a different channel 82 and different orifices 70, thereby directing fluid into specific and different areas of the filter media retainer 14 and/or the underdrain block 12 of the underdrain system 10.

The fluid flushes media and other unwanted material into the secondary chambers 28 of the underdrain block 12. The media and unwanted materials are further flushed through the channels 32 provided on internal walls 24 of the underdrain block 12 and into the primary chamber 26. The media and unwanted materials, now in the primary chamber 26, can be flushed toward the effluent collection chamber 40, such as a flume, for removal.

While various embodiments were provided in the foregoing description, those skilled in the art may make modifications and alterations to these embodiments without departing from the scope and spirit of the invention. For example, it is to be understood that this disclosure contemplates that, to the extent possible, one or more features of any embodiment can be combined with one or more features of any other embodiment. Accordingly, the foregoing description is intended to be illustrative rather than restrictive. The invention described hereinabove is defined by the appended claims and all changes to the invention that fall within the meaning and the range of equivalency of the claims are to be embraced within their scope.

The invention claimed is:

1. An in-situ flush apparatus for a filter underdrain system comprising:
a fluid connection member having a body with a first end and a second end, the first end adapted to connect to a fluid source;
a top plate connected to the second end of the fluid connection member; and
a bottom plate opposing the top plate and adapted to engage a top portion of an underdrain system comprising an underdrain block, the bottom plate comprising orifices that distribute fluid to the underdrain system to transport materials through the underdrain system.

2. The apparatus of claim 1, further comprising a middle plate positioned between the top plate and the bottom plate, the middle plate comprising a plurality of channels.

3. The apparatus of claim 2, wherein the plurality of channels direct fluid to the orifices of the bottom plate.

4. The apparatus of claim 3, wherein the fluid connection member comprises valves to control the flow of water from the fluid source.

5. The apparatus of claim 3, wherein the fluid connection member comprises a pressure gauge adapted to measure the pressure of fluid.

6. The apparatus of claim 3, wherein the fluid connection member comprises a flowmeter to control the pressure of fluid to each channel.

7. The apparatus of claim 1, further comprising a seal attached to a portion of the bottom plate.

8. The apparatus of claim 1, wherein the bottom plate is adapted to engage a top wall of the underdrain block.

9. The apparatus of claim 1, wherein the underdrain system further comprises a media retainer and the bottom plate is adapted to engage the media retainer.

10. A system for cleaning unwanted materials from a water or waste water treatment filter comprising:
an underdrain system comprising an underdrain block;
a fluid source; and
an in-situ flush apparatus comprising:
a fluid connection member having a body with a first end and second end, the first end adapted to connect to the fluid source;
a top plate connected to the second end of the fluid connection member; and
a bottom plate opposing the top plate and adapted to engage a top portion of the underdrain system, the bottom plate comprising orifices that distribute fluid to the underdrain system from the fluid source to transport materials through the underdrain system.

11. The system of claim 10, further comprising a middle plate positioned between the top plate and the bottom plate, the middle plate comprising a plurality of channels.

12. The system of claim 10, further comprising an effluent collection chamber that receives the materials transported through the underdrain block.

13. The system of claim 12, wherein the effluent collection chamber is a flume.

14. The system of claim 12, further comprising a hose extending from the effluent collection chamber to the underdrain block.

15. The system of claim 10, further comprising a downcomer stem positioned in a top wall of the underdrain block.

16. The system of claim 10, wherein the underdrain system further comprises a filter media retainer positioned on top of the underdrain block.

17. A method of transporting materials through an underdrain system, the method comprising:
positioning an in-situ flush apparatus onto a top portion of an underdrain system, the flush apparatus comprising a fluid connection member having a body with a first end and a second end, a top plate, and a bottom plate opposing the top plate;
attaching the first end of the fluid connection member to a fluid source; and
distributing fluid from the fluid source, out of the flush apparatus through orifices positioned in the bottom plate, and into the underdrain system.

18. The method of claim 17, wherein the flush apparatus further comprises a middle plate positioned between the top plate and the bottom plate, the middle plate comprising a plurality of channels.

19. The method of claim 18, wherein the channels direct fluid to designated orifices in the bottom plate.

20. The method of claim 17, further comprising transporting materials from the underdrain system and into an effluent chamber.
